(19) United States
(12) Patent Application Publication
(10) Pub. No.: US 2006/0086426 A1
(43) Pub. Date: Apr. 27, 2006

(54) Cross-cut log tile

(76) Inventors: Momcilo M. Filipovich, Westmont, IL (US); Milan Filipovich, Oak Brook, IL (US)

Correspondence Address: MOMCILO M FILIPOVICH, 211 E NAPERVILLE RD, WESTMONT, IL, 60559, US

(21) Appl. No.: 10/944,655

(22) Filed: Sep. 20, 2004

(51) Int. Cl. B27D 1/00

(52) U.S. Cl. 144/346

(57) ABSTRACT

The “Cross-Cut Log Tile” is a product who's primary design is to add style and luxury to homes, offices, hotels, resorts, and where ever it may be applicable. Previous to the invention of the “Cross-Cut Log Tile”, no other product on the market contained the design stated here. Traditionally, homeowners could only choose wood products that are different in color to diversify their homes and offices. For example, if a home owner wanted to install wooden flooring, the only choice available was a single design that varied only in the color and size of the pieces of the product. The wood was cut vertically for every piece, thus they all looked the same. So the only choice a person would have is the color of the wood. Now comes the “Cross-Cut Log Tile”. For the first time ever, wood is cut horizontally. As a result, the product contains a dazzling display of wood circles, with the natural beauty of wood exposed like never before. No more boring and traditional wood flooring! Now there is a choice for everyone!

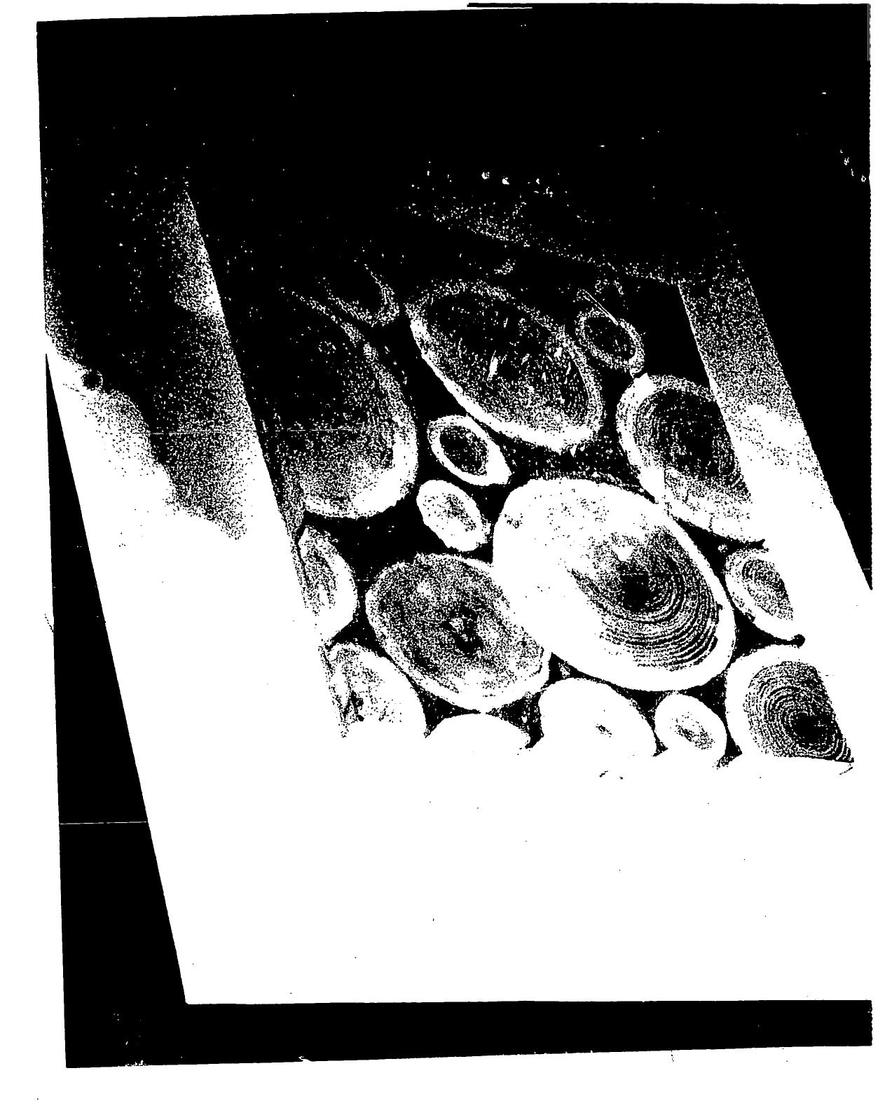

### INVENTION BACKGROUND

The “Cross-Cut Log Tile” is a new invention in the field of Home Improvement and in the field of wood products. It is designed to improve the looks and quality of homes, offices, hotels and where ever it may be applicable. It is designed to add luxury anywhere it is installed by adding genuine wood and the beauty of nature. The “Cross-Cut Log Tile” is meant to be sold side by side with other wood products such as wood flooring . . .

### CROSS-CUT TILE

### Product Description & Information

The “Cross-Cut Log Tile” is a unique product that is produced by cutting logs into thin circular sheets, then laying them flat onto a wooden board, joined by glue. The product is then cut into predetermined sizes, forming squares. Once the wood is cut into squares, it is then treated with various types of wood stain, thus giving it its rich and durable finish.

This product is intended to be used on walls and floors. It is ideal for basements, fireplaces, cabin rooms, and anywhere wood may be used. It is the world's first use of the natural beauty of wood being cut horizontally.

Name: Cross Cut Log Tile

Composition: Wood, glue, wood polish

Physical Properties: Square tiles in various dimensions and colors

Intended Use: Homes, Hotels, Resorts.

### DETAILED DESCRIPTION OF PRODUCT

The “Cross-Cut Log Tile” represents the first ever use of the beauty of horizontally cut wood The product consists of thin cut sheets of wood logs, which are then positioned flat onto a wooden tile and secured using glue.

The “Cross-Cut Log Tile” begins its life as timber is cut horizontally into foot long pieces. These pieces are then carefully cut into quarter inch thin sheets, further making them flatter and easier to work with. A large piece of flat wood board of plywood is then covered with wood glue or any similar adhesive, and these thin sheets of log are placed flat on top of the wood. Seperatly, the by-product that is saw dust is mixed with glue into a paste that is then used to fill the gaps between the log sheets.

Once the glue is cured, and the logs are in place, the product is cut into various size tiles. Depending on their use, they can be anywhere from foot by foot or larger. The tiles are then sanded on every surface, making them smooth to the touch. More importantly, the sanding process further polishes the wood, and shows of the naturally beautiful wood, with the circles of logs creating a maze of circles within a tile.

In the final step, the tiles are dipped into wood finish, securing their natural beauty and providing the product with durability and protection from elements.

What makes the “Cross-Cut Log Tile” such a breakthrough product is that it has the potential to change the entire market. Never before has wood been used in a fashion such as this. For a long time, wood products were always made is the same fashion. They were cut vertically, into long and very narrow boards. The perfect example would be wood flooring. Though beautiful, the wood floors always looked the same, as there was never any real variation. They were always cut in the same fashion, and made the same way . . .

Enter “The Cross-Cut Log Tile”. For the first time, wood is cut horizonally. Now consumers can choose a different design. Unlike regular wood flooring, this product can also be used on walls as well, due to its design. And when taking into consideration that there are many species of wood, and many different wood stains and finishes, the combination of color and size is infinite. A person can say, “the game has changed . . . ”

Finally, the “Cross-Cut Log Tile” is very easy to make, and the cost is minimal. The average adult can make this product in their garage being that the supplies and the machines needed can be found in any hardware store . . .

We claim

1. We claim that horizontally cutting wood logs, placing them onto a flat wooden board, and then cutting them into tiles using these logs is our invention. We claim to be the first to come up with this idea, and to the best of our knowledge we are responsible for its inception.
